(19) United States
(12) Patent Application Publication
(10) Pub. No.: US 2024/0107267 A1
(43) Pub. Date: Mar. 28, 2024

(54) SYSTEMS AND METHODS FOR POSITIONAL TRACKING OF INTERACTIVE DEVICES

(71) Applicant: Universal City Studios LLC, Universal City, CA (US)

(72) Inventors: Rachel E. Rodgers, Orlando, FL (US); Wei C. Yeh, Orlando, FL (US)

(21) Appl. No.: 17/950,714

(22) Filed: Sep. 22, 2022

(51) Int. Cl. H04W 4/02; A63G 31/00; G01S 13/02; G01S 13/10; G01S 13/32; G06F 3/01

(52) U.S. Cl. CPC H04W 4/026; A63G 31/00; G01S 13/0209; G01S 13/10; G01S 13/32; G06F 3/011

(57) ABSTRACT

An interactive device includes antennas, one or more transceivers coupled to the antennas, one or more feedback devices, and one or more processors coupled to the one or more transceivers and the one or more feedback devices. The one or more processors receive, via the one or more transceivers, the signals from a computing device. Additionally, the one or more processors may determine a time of flight corresponding to receipt of the signals by the antennas. The one or more processors also determine position information, orientation information, or both, of the interactive device based on the time of flight. Further, the one or more processors transmit the position information, the orientation information, or both, to an environment controller via the one or more transceivers. Further still, the one or more processors activate the one or more feedback devices based on the position information, the orientation information, or both.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Amusement parks often include interactive areas, including rides and attractions. Some interactive areas may include features that provide the same user experience for every user. However, providing different or unique features that may be tailored for each user may enhance and provide better user experiences for each user. It is now recognized that it is desirable to provide different or unique features in interactive areas of amusement parks that provide different or unique user experiences for each user based on, for example, user input.

### BRIEF DESCRIPTION

Certain embodiments commensurate in scope with the originally claimed subject matter are discussed below. These embodiments are not intended to limit the scope of the disclosure. Indeed, the present disclosure may encompass a variety of forms that may be similar to or different from the embodiments set forth below.

In one embodiment, an interactive device includes a plurality of antennas, one or more transceivers coupled to the plurality of antennas, one or more feedback devices, and one or more processors coupled to the one or more transceivers and the one or more feedback devices. The one or more processors may receive, via the one or more transceivers, the signals from a computing device. Additionally, the one or more processors may determine a time of flight corresponding to receipt of the signals by the plurality of antennas. Further, the one or more processors may determine position information, orientation information, or both, of the interactive device based on the time of flight. Even further, the one or more processors may transmit the position information, the orientation information, or both, to an environment controller via the one or more transceivers. Further still, the one or more processors may activate the one or more feedback devices based on the position information, the orientation information, or both.

In one embodiment, a method includes transmitting, using a transmitter, a first ultra-wideband (UWB) signal to be received by a plurality of antennas of an interactive device being utilized within an interactive environment. The method also includes receiving, using a receiver, a second UWB signal indicating position information, orientation information, and an interactive device ID associated with the interactive device being utilized within the interactive environment. Further, the method includes updating, using the one or more processors, one or more features within the interactive environment based on the position information, the orientation information, and the interactive device ID.

In one embodiment, an interactive system includes an environment controller having a transceiver that transmits a signal. The interactive system also includes a plurality of interactive devices. Each interactive device of the plurality of interactive devices includes a plurality of antennas, one or more transceivers, and one or more processors. The one or more processors of each interactive device is configured to receive a signal from the one or more transceivers via the plurality of antennas of a respective interactive device. The one or more processors of each interactive device is also configured to determine a time of flight of the signal based on receipt of the signal via the plurality of antennas. Further, the one or more processors of each interactive device is configured to determine position information and orientation information based on the time of flight of the signal. Further still, the one or more processors of each interactive device is configured to transmit the position information and the orientation information to the environment controller via the plurality of antennas, wherein the environment controller, upon receipt of the position information and the orientation information, is configured to adjust one or more features of an amusement park.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is schematic diagram of an interactive device system for tracking position information, orientation information, or both, and for providing customizable user experiences, in accordance with an aspect of the present disclosure;

FIG. 2 is a block diagram illustrating the interactive device system of FIG. 1, in accordance with an aspect of the present disclosure;

FIG. 3 is a data flow diagram illustrating communication between an interactive device and an environment controller of the interactive device system of FIG. 1, in accordance with an aspect of the present disclosure;

FIG. 4 is a block diagram illustrating an interactive device with multiple transceivers communicating via multiple antennas with an external transceiver, in accordance with an aspect of the present disclosure; and

FIG. 5 is a block diagram illustrating an interactive device with a transceiver communicating via multiple antennas with an external transceiver, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In certain environments, such as an attraction within an amusement park (e.g., amusement park rides, performance shows, and games), a user may be provided access to a tool to provide an immersive experience within the amusement park. The user's interactions with the tool may be recorded and provide certain benefits to the user, such as awarding points. To provide a more desirable experience (e.g., a more immersive experience or user-friendly experience), it may be advantageous to utilize an interactive tool having multiple antennas disposed in different positions on the interactive tool.

The present disclosure relates to an interactive device system that provides positional and/or orientation tracking of an interactive device being utilized within an interactive environment based on signals transmitted from an external transceiver (e.g., via an antenna) to multiple antennas disposed on the interactive device. In general, the antennas of the interactive device are disposed in different locations (e.g., on one or more surface, such as one or more interior surfaces, one or more exterior surfaces, or both) of the interactive device. As such, signals transmitted by the external transceiver may be received by each antenna during a time that is related to a distance between each antenna and the external transceiver. A processor of the interactive device receives signals via multiple antennas associated with one or more transceivers and determines a time of flight indicating the time the antennas received the signals. For example, the time of flight information may indicate a first timestamp corresponding to transmission of the signals by the transceiver via its antennas and a second timestamp corresponding to receipt of the signals by a transceiver or receiver via its the antennas (e.g., a timestamp corresponding to receipt of signals by each interactive device, a difference in the timestamp corresponding to receipt of the signal, and the like). Based on the determined time of flight, the processor may communicate (e.g., via ultra-wideband (UWB) communication) signals that include position information (e.g., three-dimensional Cartesian coordinates, polar coordinates, and the like), orientation information (e.g., a direction a particular location of the interactive device is facing, a degree of roll, pitch, and/or yaw of the interactive device), or both, to an external controller (e.g., an environment controller), which may cause the environment controller to adjust one or more features of the interactive environment. In some embodiments, the interactive device may be a wearable device, a handheld device, or any of a variety of devices that are otherwise configured to be carried (e.g., held or worn) by the user. For example, the interactive device may be a wand, a helmet, a bracelet, a headband, a head-mounted display (e.g., including or configured to couple to the headband or other structure that supports the head-mounted display on a head of the user; configured to display images for visualization by the user wearing the head-mounted display to create augmented reality [AR], virtual reality [VR], or mixed reality [both AR and VR] experiences for the user wearing the head-mounted display), or other device. Additionally or alternatively, in some embodiments, the interactive device may be an interactive tool, such as a projectile launcher, including a slingshot, a bow, a catapult, a blaster, water hose, or other device that is capable of emitting, shooting, or launching virtual or physical projectiles, fluids, or lights, used in an interactive environment. In any case, the orientation information and position information may be used to determine to whether the projectiles, virtual or physical, as well as the projectile launcher, are aiming or otherwise interacting with the one or more features of the interactive environment. As such, the disclosed interactive device system (e.g., projectile device system) may provide a more desirable experience for the user. Moreover, using multiple antennas may facilitate tracking orientation information and/or position information without the use of expensive and/or sensors utilizing a relatively large amount of power, such as an inertial measurement unit (IMU).

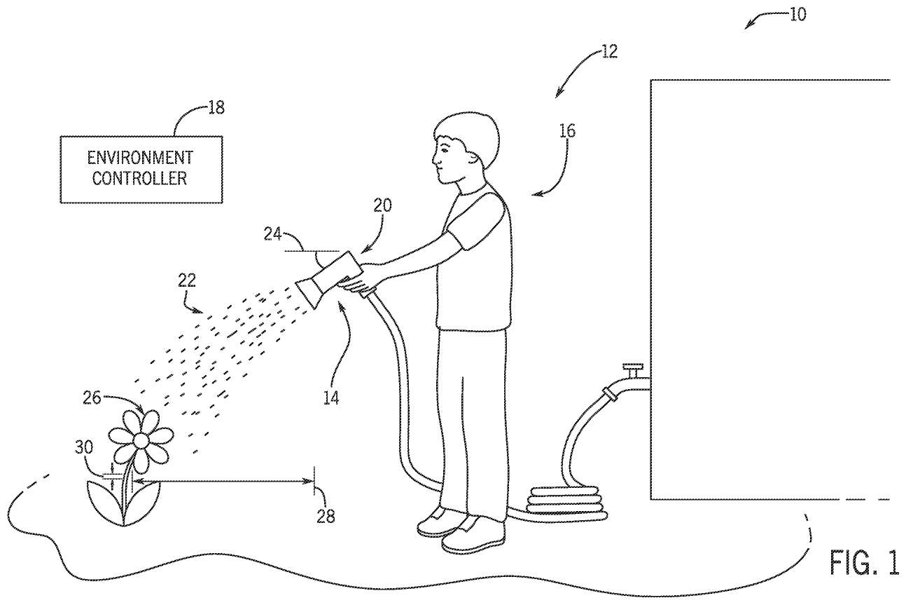

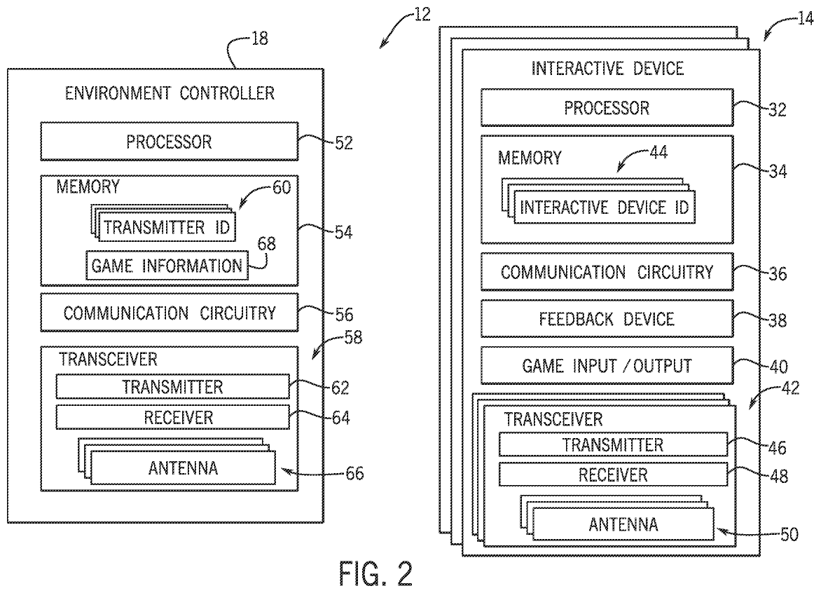

With the foregoing in mind, FIG. 1 is a schematic diagram showing a perspective view of an interactive environment 10 with an interactive device system 12 having an interactive device 14. As shown, the interactive environment 10 includes a user 16 holding the interactive device 14. While only one user 16 and one interactive device 14 are shown, another embodiment of the interactive device system 12 may include any number (e.g., one or more, two or more, three or more, four or more, five or more, and so on) of interactive devices 14 with any number (e.g., one or more, two or more, three or more, four or more, five or more, and so on) of users 16. In general, the interactive device 14 may include an electronic device having a processor and communication circuitry that communicates with an environment controller 18 via wireless communication or wired communication, as described in more detail with respect to FIG. 2. In general, the environment controller 18 is also an electronic device (e.g., a computing device) having a processor and communication circuitry, such as a server, a desktop computer, a laptop, a mobile device, a smart phone, and the like. For example, the interactive device 14 may transmit signals indicating data to the environment controller 18 via antennas using ultra-wideband (UWB) communication (e.g., at a frequency between 3.1 gigahertz (GHz) to 10.6 GHz), radio frequency identification (RFID) beacons and/or tags (e.g., at approximate frequencies of 433 megahertz (MHz) or 860-960 MHz), or Wi-Fi (e.g., at approximate frequencies of 2.4 GHz or 5 GHz). The interactive device 14 may include a trigger 20 that a user 16 may select, pull, or otherwise activate, thereby causing the interactive device 14 to emit, shoot, or launch a projectile 22, such as a virtual projectile (e.g., a virtual laser beam, a virtual fluid stream, a virtual arrow, a virtual cannonball, and the like) or a physical projectile (e.g., a foam part, a fluid stream, and the like). In general, the interactive device 14 may include an interactive tool, such as a projectile launcher (e.g., a slingshot, a bow, a catapult), a blaster, water hose, or any other suitable device that is capable of emitting, shooting, or launching virtual projectiles or physical projectiles, used in the interactive environment 10.

In general operation, to facilitate tracking the position, orientation, and utilization of the interactive device 14, the environment controller 18 may communicate, transmit, or otherwise output signals (e.g., a signal indicating the information) using a transceiver via one or more antennas to multiple antennas (not shown) on the interactive device 14. For example, the environment controller 18 may transmit signals to the antennas of the interactive device 14 (e.g., via the antennas of the interactive device 14) while the interactive device 14 is in proximity of an interactive device 14 (e.g., within UWB range, such as within 5 meters (m), 10 m, 50 m, 100 m, and so on), which is used by the interactive device 14 to determine position information, orientation information, or both. The signal may include a transmitter ID, such as a pattern or set of alphanumeric characters and/or symbols that generally indicate the particular transceiver communicating the signal. In some embodiments, the environment controller 18 (e.g., the transceiver of the environment controller 18) may transmit the signal via the antenna periodically or based on certain trigger conditions (e.g., the user 16 selecting, pulling, or otherwise activating the trigger 20). In any case, a processor of the interactive device 14 may determine time data corresponding to receipt of the signal by each of the antennas, such as the time of flight. That is, the processor of the interactive device 14 may determine that a first antenna received data signal from the transmitter (i.e., transmitted by an antenna associated with the transmitter) during a first time, and the processor of the interactive device 14 may determine that a second antenna received the data signal from the transmitter during a second time. Then, the processor of the interactive device 14 may determine a position information, orientation information, or both of the interactive device 14 based on the time data corresponding to receipt of the signal by each of the antennas.

For example, the processor of the interactive device 14 may determine an angular tilt 24 (e.g., a roll, yaw, and/or pitch) of the interactive device 14 relative to one or more axes. That is, the processor may determine an amount of degrees the interactive device 14 is tilted to the left/right and/or up/down relative to a normal direction. Additionally or alternatively, the processor may determine a relative direction that the interactive device 14 is facing. That is, in an interactive environment 10 including one or more features, such as virtual features (e.g., characters or targets displayed on a screen or projected via augmented reality devices) or physical features (e.g., a physical target, other users within the interactive environment, barriers, characters within the environment). The relative direction may indicate whether a particular end (e.g., a projectile firing end) of the interactive device 14 is aiming at one or more of the features. Then, the interactive device 14 may transmit signals indicating orientation information indicating the tilt 24, as well as position information, to the environment controller 18.

Additionally or alternatively, the processor may determine position information, such as a relative position of the interactive device 14 within the interactive environment. For example, the processor may determine three-dimensional Cartesian coordinates, polar coordinates, and the like, of the interactive device 14. In some embodiments, the position information may include a location within the interactive environment 10 of where the interactive device 14 is being utilized (e.g., fired or aimed). For example, the location may correspond to a safety or no-firing zone (e.g., having virtual characters that it is intended that the user 16 not aim or fire a projectile 22 towards), a zone with barriers (e.g., physical barriers or virtual barriers) that reflect or deflect projectiles 22, and the like.

In any case, the interactive device 14 may communicate one or more signals indicating the position information and/or the orientation information to the environment controller 18. In turn, the environment controller 18 may update the interactive system 10 based on the position information and/or orientation information corresponding to the position and/or the orientation of the interactive device 14. For example, in an embodiment when the interactive device 14 is a projectile launcher, the environment controller 18 may determine whether the interactive device 14 is aiming towards a feature 26 (e.g., a target) based on the angular tilt 24 and/or a distance 28 between the interactive device 14 and the feature 26. As another non-limiting example, the environment controller 18 may determine whether the projectile 22 corresponding to the interactive device 14 will hit a portion 30 of the feature 26. In any case, interactions between the user 16 and the interactive device 14 and/or features 26 within the interactive environment 10 may be tracked and/or recorded, such as by updating data stored in a databases or other accessible storage components, to include a record of the interactions with the interactive device 14, awarding points to the user 16 based on using the interactive device 14, tracking progress of the user 16 when using the interactive device 14, tracking achievements of the user 16 when using the interactive device 14, and the like.

To perform the operations described herein, the interactive device 14 and the environment controller 18 may each include certain processing circuitry, memory circuitry, and communication circuitry. To illustrate, FIG. 2 is a block diagram of the interactive device system 12 including one or more interactive devices 14 and the environment controller 18. In an embodiment, the one or more interactive devices 14 may each include a processor 32, a memory 34, and communication circuitry 36 to enable the one or more interactive devices 14 to communicate with the environment controller 18. The various functional blocks shown in FIG. 2 may include hardware elements (including circuitry), software elements (including machine-executable instructions) or a combination of both hardware and software elements (which may be referred to as logic). The processor 32, memory 34 and/or nonvolatile storage, the communication circuitry 36, and/or the feedback device 38 may each be communicatively coupled directly or indirectly (e.g., through or via another component, a communication bus, a network) to one another to transmit and/or receive signals indicating data between one another. It should be noted that FIG. 2 is merely one example of a particular implementation and is intended to illustrate the types of components that may be present in the interactive device 14 and/or the environment controller 18.

The interactive device 14 may also include a game input/output control element 40, which may include an input trigger, button, joystick, control pad, or other selectable features, and/or similar features as the feedback device 38 (e.g., speaker, display, light-emitting device, haptic device, and so on). The game input/output 40 may provide a trigger condition to the environment controller 18 that causes the environment controller 18 to track the position and/or orientation of the interactive device 14, which may facilitate certain game elements within an interactive environment 10. In general, the trigger condition may indicate interactions between the user and the interactive device 14. For example, the trigger condition may indicate whether a user is pulling a trigger (e.g., the trigger 20 described with respect to FIG. 1) of the interactive device 14 (e.g., in an embodiment where the interactive device 14 is a projectile launcher). As another non-limiting example, the trigger condition may indicate a direction of movement or a particular motion of the shareable device (e.g., a user waving a wand in a specific pattern). As another non-limiting example, the trigger condition may indicate that the user is pressing a particular button of the game input/output 40. In this way, the trigger condition may be utilized by the environment controller 18 to enable tracking of the interactive device 14.

The communication circuitry 36 may include, for example, one or more communication circuitry 36 for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the communication circuitry 36 may include one or more communication circuitry for using a cellular communication standard of the 5G specifications that include the millimeter wave (mmWave) frequency range (e.g., 24.25-300 gigahertz (GHz)) that defines and/or enables frequency ranges used for wireless communication. In some embodiments, the communication circuitry 36 may include a transmitter and/or receiver that support transmission and receipt of various wireless signals via one or more antennas. For example, the communication circuitry 36 may include multiple transmitters, multiple receivers, multiple transceivers, and/or multiple antennas as suitable for various communication standards.

As illustrated, the interactive device 14 may include one or more transceivers 42. In some embodiments, all or portions of the transceiver 42 may be disposed within the processor 32. The transceiver 42 may support transmission and receipt of various wireless signals via one or more antennas 50, and thus may include a transmitter 46 and a receiver 48. Accordingly, the transceiver 42, the transmitter 46, and the receiver 48 may receive signals via one or more of the antennas 50. In general, the transmitter 46 and the receiver 48 may enable communication with the environment controller 18, as described in more detail below. For example, the transmitter 46 of the interactive device 14 may transmit a signal that indicates an interactive device ID 44, position information, and/or orientation information of the interactive device 14 to the environment controller 18 via the antennas 50.

The environment controller 18 may include a processor 52, a memory 54, and communication circuitry 56 to enable the environment controller 18 to communicate with the one or more interactive devices 14. In an embodiment, the environment controller 18 may scan (e.g., periodically or based on certain trigger conditions, such as activation of the trigger 20 of the interactive device 14, and so on) for and/or transmit a signal that includes the transmitter ID 60 to the interactive device 14. For example, the environment controller 18 may use the communication circuitry 56 to scan for signal indicating the interactive device ID 44, position information, orientation information, or a combination thereof from the interactive devices 14. In general, the interactive device ID 44 may include a set of alphanumeric characters and/or symbols that identify a particular interactive device 14 (e.g., interactive device ID). In some embodiments, the communication circuitry 56 may use any suitable type of communication, such as Bluetooth, Wi-Fi, or the like. In general, the processor 52 may include similar components and perform similar functions as described with respect to the processor 32, the communication circuitry 56 may include similar components and perform similar functions as described with respect to the communication circuitry 36. The memory 54 of the environment controller 18 may store a transmitter ID 60 that identifies a particular transmitter 62. Further, the memory 54 may store game information 68 that generally identifies, characterizes, or stores historical information associated with features 26 of the interactive environment 10.

In an embodiment, the environment controller 18 may determine an interaction between the interactive device 14 and the user 16, and in turn, transmit, output, or otherwise provide an indication that causes the interactive device 14 to provide feedback indicating the interaction. That is, the indication may cause one or more feedback devices 38 (e.g., visual feedback devices (e.g., light-emitting elements such as diodes, a display screen), audio feedback devices (e.g., speakers), haptic elements, and the like) of the interactive device 14 to activate based on the position information, the orientation information, or a combination thereof, received by the environment controller 18. In some embodiments, the memory 54 may store a user profile including certain user preferences (e.g., graphics, images, and other visuals, audio, and haptics patterns that the user has previously selected) that the user may provide to improve immersion of the user with an interactive environment. For example, the user may prefer that the interactive device present a particular color scheme (e.g., blue), and a light emitter(s) (representative of the feedback device 38) on the interactive device 14 may illuminate in a color (e.g., blue) that corresponds to the color scheme upon a successful hit or the interactive device 14 aiming at a feature (e.g., red if aiming at a friendly character within the interactive environment, or green if aiming at a target for awarding points), as described herein.

As illustrated, the environment controller 18 may include one or more transceivers 58. In some embodiments, all or portions of the transceiver 58 may be disposed within the processor 52. The transceiver 58 may transmit and receive various wireless signals via one or more antennas 66, and thus may include a transmitter 62 and a receiver 64. Accordingly, the transceiver 58, the transmitter 62, and the receiver 64 may receive signals via one or more of the antennas 66. In general, transmitter 62 and the receiver 64 enable communication with the interactive device 14 via the transmitter 46 and the receiver 48 of the interactive device 14. For example, the transmitter 62 of the environment controller 18 may transmit the signal indicating the transmitter ID 60 to the interactive device 14. More specifically, the receiver 48 of the interactive device 14 may receive the signal indicating transmitter ID 60 via the antennas 50. Further, the receiver 64 may receive, via the antenna 66, the signal indicating signal indicating the interactive device ID 44, position information, and/or orientation information that are transmitted by the transmitter 46 of the interactive device 14 via the antenna 50. In this way, the interactive device 14 and the environment controller 18 may be communicatively coupled. As described in more detail below, communicatively coupling the interactive device 14 and the environment controller 18 may facilitate tracking position information and/or orientation information of the interactive device 14 as it is used within the interactive environment 10.

In some embodiments, the interactive device system 12 may include multiple transceivers 58 and multiple interactive devices 14. For example, the interactive device system 12 may include 2, 3, 4, 5, or more than 5 transceivers 58 and 2, 3, 4, 5, or more than 5 interactive devices 14. In such embodiments, it may be advantageous to have a subset of the transceivers 58 be dedicated to a subset of the interactive devices 14. That is, a first subset of the transceivers 58 may only communicate with a first subset of the interactive devices 14 (e.g., via first range of frequencies), and a second subset of the transceivers 58 may only communicate with a second subset of the interactive devices 14 (e.g., via a second range of frequencies). In some embodiments, the environment controller 18 may determine the subset of the transceivers 58 and/or the subset of the interactive devices 14 in a static manner (e.g., predetermined subsets) or a dynamic manner (e.g., as interactive devices 14 are activated within the interactive environment). Moreover, in certain embodiments, the interactive device 14 may be carried out of a communication range of a first environment controller 18 and into a communication range of a second environment controller 18, such as when a user moves to different rooms, stages, or otherwise locations in an attraction at amusement park. In such embodiments, the second environment controller 18 may assign a new subset of transceivers 58 to the interactive device 14. In this way, the communication between the interactive device 14 and the interactive device system 12 (e.g., having one or more environment controllers 18 and/or transceivers 58 in different rooms, stages, or otherwise locations in the amusement park) is less likely to be interrupted, thereby improving the experience of the user.

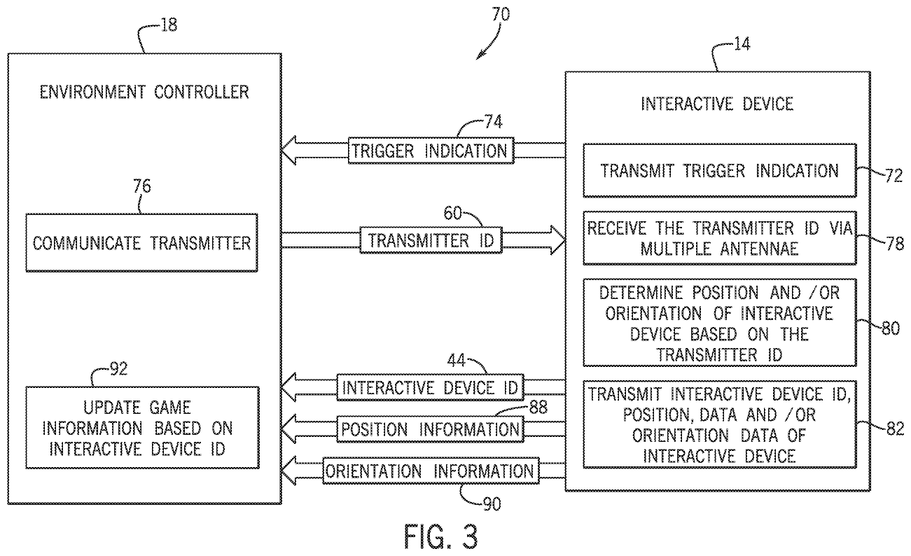

To further illustrate the techniques disclosed herein, FIG. 3 is a data flow diagram illustrating a method 70 for tracking position information and orientation information of an interactive device 14. In general, certain process blocks performed in the method 70 may be performed by the processor 32 of the interactive device(s) 14 or the processor 52 of the environment controller 18. However, for simplicity, the actions described below are being described with respect to the interactive device 14 rather than the processor 32, and the environment controller 18 rather than the processor 52. Moreover, certain process blocks may be performed in a different order than that illustrated, and, indeed, in some embodiments, certain process blocks may be skipped altogether.

As shown in the illustrated embodiment, in process block 72, the interactive device 14 transmits a signal (e.g., a data signal) indicating a trigger indication 74 (e.g., trigger indication signal). In general, the interactive device 14 may transmit the signal indicating the trigger indication 74 based on an interaction between the user 16 and the interactive device 14. For example, the interactive device 14 may transmit the signal indicating trigger indication 74 in response to a user pulling the trigger 20 of the interactive device 14 (e.g., in an embodiment where the interactive device 14 is a blaster). As another non-limiting example, the trigger indication 74 may indicate a direction of movement or a particular motion of the interactive device 14 towards any features 26 of the interactive environment, a specific pattern (e.g., to imitate a spell cast by a wand), and so on.

As shown in the illustrated embodiment, in process block 76, the environment controller 18 communicates or otherwise transmits a signal indicating a transmitter identifier (ID) 60 (e.g., a transmitter ID signal) to the interactive device 14 (e.g., in response to receiving the trigger indication 74 from the interactive device 14) (e.g., via the antennas 66 of the environment controller 18). In general, the transmitter ID 60 may include a set of alphanumeric characters or symbols that identify a particular transmitter 62. As described in further detail below, the interactive device 14 may utilize the transmitter ID 60 or other information included within the signal that is transmitted, communicated, or otherwise output by the transceiver 42 of the interactive device 14 (e.g., via the antennas 50) to determine position information 88, orientation information, or both corresponding to the interactive device 14. It should be noted that in some embodiments, the transmitter ID 60 may be transmitted subsequent to receipt of the trigger indication 74. For example, the interactive device 14 may transmit a signal indicating the trigger indication 74 after the user pulls the trigger 20 of the interactive device 14 and the environment controller 18 communicates the transmitter ID 60 in response to receiving the trigger ID 60. In this way, by selectively transmitting the signal indicating the transmitter ID 60 that is used to perform certain processes by the interactive device 14, the method 70 may reduce the amount of computational resources utilized by the interactive device 14 that may otherwise be used for other processes. However, in some embodiments, the environment controller 18 may communicate (e.g., periodically or otherwise) the signal indicating transmitter ID 60 to the interactive device 14 without receiving the trigger indication 74.

As shown in the illustrated embodiment, in process block 78, the interactive device 14 receives signal indicating the transmitter ID 60 via the multiple antennas 50 of the interactive device 14. In turn, in process block 80, the interactive device 14 determines position information 88 and/or orientation information 90 based on receipt of the transmitter ID. In general, the interactive device 14 may determine a time of flight corresponding to a time when a signal (e.g., a signal indicating the transmitter ID 60) was sent by the antenna 66 and/or received by each of the antennas 50. Accordingly, the time of flight may vary based on a distance between the antenna 66 and each antenna 50. As such, the time of flight for each of the antennas 50 may correspond to or otherwise be related to a particular position and/or orientation of the interactive device 14. In some embodiments, the interactive device 14 may determine the time of flight of the transmitter ID 60 using timestamps corresponding to sending and receiving the transmitter ID 60. For example, the transmitter ID 60 may be sent as a signal that includes a first timestamp corresponding to a first time when the signal was sent. Further, the interactive device 14, upon receiving the signal that includes the transmitter ID 60 and the timestamp, may generate a second timestamp that corresponds to a second time when the signal was received. Accordingly, the difference between the second time (e.g., of the second timestamp) and the first time (e.g., of the first timestamp) may indicate the time of flight of the signal sent by the environment controller 18.

For example, the interactive device 14 may access a first reference data (e.g., a reference table) indicating an orientation of the interactive device 14 that corresponds to certain time ranges for each of the antenna 50. Additionally or alternatively, the interactive device 14 may access reference data indicating the position of the interactive device 14 that corresponds to the certain time ranges for each of the antennas 50. For example, the reference data may indicate the spatial or tilt arrangement of the antennas 50 on one or more surfaces of the interactive device 14. In some embodiments, the interactive device 14 may store a model indicating relationships between the position, orientation, and/or relative times for receipt of the transmitter ID 60 by the antennas 50. In any case, the interactive device 14 may determine position information 88 and/or orientation information 90 based on the received signal transmitted by the environment controller 18 via the antennas 66.

As shown in the illustrated embodiment, in process 82, the interactive device 14 transmits one or more signals indicating an interactive device ID 86 (e.g., an interactive device ID signal), position information 88 (e.g., a position signal), and/or orientation information 90 (e.g., an orientation signal) to the environment controller 18. In some embodiments, one or more of the interactive device ID 86, the position information 88, and/or the orientation information 90 may be transmitted in a single signal. In general, the interactive device ID 86 may indicate a particular interactive device 14, thereby enabling the environment controller 18 to determine the particular interactive device 14 that is interacting with the interactive environment 10. The position information 88 may include coordinates (e.g., three-dimensional Cartesian coordinates, two-dimensional Cartesian coordinates, polar coordinates, and the like) or another representation of a position of the interactive device 14 within a space. The orientation information 90 may include aim information, such as data indicating a direction that the interactive device 14 is aiming. In some embodiments, the orientation information 90 may include roll, yaw, and/or pitch information, such as data indicating a tilt of the interactive device 14 (e.g., a degree of inversion or twist of the device relative to a neutral position).

As shown in the illustrated embodiment, at process block 92, the environment controller 18 may update game information based on the interactive device ID 44, the position information 88, and/or the orientation information 90. In general, updating the game information may including adjusting certain features 26, awarding points (e.g., updating information stored in a database), causing the feedback devices 38 to activate, or transmitting notifications to a user device (e.g., a mobile device). In some embodiments, the environment controller 18 may determine a user profile that is paired to interactive device 14 based on the interactive device ID 44. For example, the environment controller 18 may determine that the position information 88 indicates that the user 16 is in a no-fire zone and the orientation information 90 indicates that the user 16 is aiming the interactive device 14. As such, the environment controller 18 may cause a feedback device 38 to output an audio message (e.g., “watch yourself, soldier,” “hey! I'm on your side,” and so on). Additionally or alternatively, the environment controller 18 may cause the features 26 to attempt to avoid the aiming of the interactive device 14 (e.g., cause a display depicting virtual characters to duck or jump out of the way of the direction the interactive device 14 is aiming). In one embodiment, updating game information may include determining a number of successful interactions between the interactive device 14 and the features 26 within the interactive environment 10. For example, each feature 26 may be a target that a user 16 desires to hit with a projectile (e.g., a virtual projectile) launched by the interactive device 14. As such, updating the game information may include storing a number that indicates the number of successful hits scored by a user 16. In one embodiment, updating game information may include actuating one or more features (e.g., physical features controlled by mechanical actuation) disposed within the interactive environment. For example, the environment controller 18 may send a control signal that causes a physical feature, such as a mechanical flower, to rise or fall upon being hit with a projectile corresponding (e.g., rise if the projectile is water).

As another non-limiting example, the environment controller 18 may determine that the trigger 20 of the interactive device 14 was pulled. As such, the environment controller 18 may cause a display of the interactive device system 12 to depict projectiles in a location that corresponds to the position information 88 and the orientation information 90. In some embodiments, the environment controller 18 may access user information, such as a game profile associated with the user 16, and generate an effect on the display that corresponds to certain user profile settings. For example, the game profile may indicate that the user 16 has selected water as a projectile. As such, the display may depict water being emitted by the interactive device 14. Furthermore, in such embodiments, the environment controller 18 may adjust the features 26 based on the type of projectile. For example, if the environment controller 18 determines that the user 16 has fired a flame projectile at a feature 26 that is a flower, the environment controller 18 may cause the display to indicate that the flower is burning. As another non-limiting example, if the environment controller 18 determines that the user 16 has fired a water projectile at a feature 26 that is a flower, the environment controller 18 may cause the display to indicate that the flower is freshly watered and/or growing. In this way, the environment controller 18 may utilize the position information 88 and/or the orientation information 90 to provide an immersive experience for a user 16 within an interactive environment 10 by tailoring features to the user 16.

In one embodiment, the environment controller 18 may communicate additional information to the interactive device 14 based on the updated game information that causes the interactive device 14 to generally adjust operation. That is, the environment controller 18 may communicate additional information, such as an updated status information, to the interactive device 14 that generally modifies the amount of data transmitted by the interactive device 14. Modifying the amount of data transmitted by the interactive device 14 may include transmitting additional data with the trigger condition, the position information 88, the orientation information 90, or a combination thereof.

For example, the environment controller 18 may receive the trigger condition, the position information 88, the orientation information 90, or a combination thereof, that indicates a particular interaction between the user 16 and the interactive environment 10. The particular interaction may include the interactive device 14 firing a projectile at a feature 26, achieving a certain amount of points, moving the interactive device 14 within range of a feature 26, or otherwise interacting with the interactive environment 10. In turn, the environment controller 18 may determine that the particular interaction corresponds to activation of a particular mode (e.g., operational mode) of the interactive device, and thus, transmit an updated status information to the interactive device 14 that causes the interactive device 14 to operate in accordance with the particular mode.

As one non-limiting example, the mode may include a “power-up mode.” As such, if the environment controller 18 determines that interactive device 14 interacted with the feature 26 that is associated with the power-up mode, the environment controller 18 may transmit, to the interactive device 14, an updated status information indicating the power-up mode. The interactive device 14 may receive the updated status information and adjust its operation in accordance with the power-up mode. For example, the interactive device 14 may transmit a trigger condition that indicates the power-up mode when the trigger 20 is pulled. In turn, the environment controller 18, after receiving the trigger indication indicating the power-up mode, may cause the display of the interactive device system 12 to display an image of a projectile that corresponds to the power-up mode. For example, the environment controller 18 may cause the display to display relatively larger projectiles being fired by the interactive device 14, projectiles with a fire effect, and the like. Another example of a mode may include a “stuck trigger mode” that causes the interactive device 14 to transmit additional trigger conditions corresponding to the trigger 20 being pulled repeatedly or pulled for a time period that does not actually correspond to how the user is pulling the trigger 20. Another example of a mode may include a “shaky device mode” that causes the interactive device 14 to transmit an adjusted position information 88 and/or orientation information 90 (i.e., introducing noise into the position information 88 and/or the orientation information 90) that may obscure the actual position information 88 and/or the actual orientation information 90, thereby making it more difficult for the user 16 to hit a target with the interactive device 14.

In one embodiment, updating the game information may include determining whether the interactive device 14 is pointing towards a particular feature 26. For example, in an embodiment when the interactive device 14 is a flashlight, the environmental controller 18 may determine whether a beam emitted by the flashlight is pointing at the features 26, such as virtual characters. Accordingly, if the environment controller 18 determines that the beam is pointing at the virtual characters, the environment controller 18 may update the game information to cause a display to display gestures performed by the virtual characters corresponding to the beam (e.g., causing the virtual characters to cover their eyes or duck out of the way to avoid the beam). In this way, tracking positional information 88 and orientation information 90 may improve the immersion of the user 16 within the interactive environment 10.

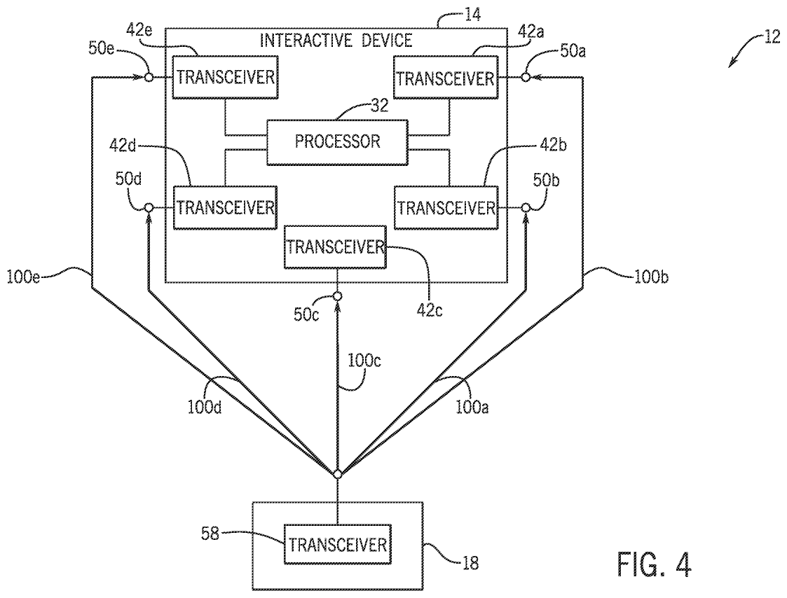

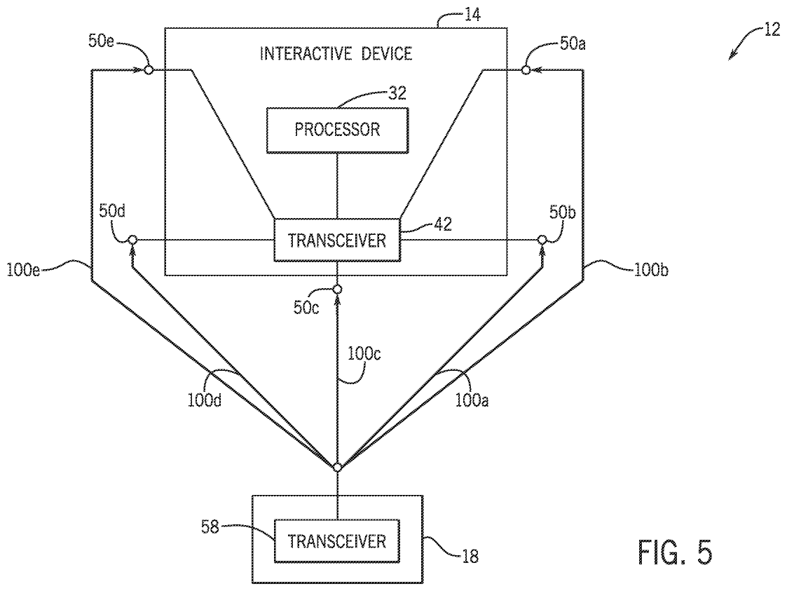

As described herein, the interactive device 14 may include multiple antennas 50 and multiple transceivers 42. For example, in an embodiment, a first antenna 50 may be controlled by a first transceiver 42 and a second antenna 50 may be controlled by a second transceiver 42. To illustrate this, FIG. 4 shows a schematic diagram of an interactive device 14 having multiple transceiver 42a, 42b, 42c, 42d, and 42e (e.g., collectively 42) that receive signals 100a, 100b, 100c, 100d, and 100e (e.g., collectively 100) via a respective antenna 50a, 50b, 50c, 50d, and 50e (e.g., collectively 50). The signals 100 may include data such as the transmitter ID 60 (e.g., as described with respect FIGS. 2 and 3) and the signals 100 is transmitted by the transceiver 58 via the antennas 66 of the environment controller 18. As described herein, the interactive device 14 may determine a position and/or orientation of the interactive device 14 based on a time that the signals 100 (e.g., the transmitter ID 60) is received by the transceiver 42. That is, the transmitter ID 60 may include a timestamp corresponding to a time when the transmitter ID 60 was sent by the transceiver 58. More specifically, each antenna 50 may be disposed at a different location on the interactive device 14 (e.g., on a top surface of the interactive device 14, on a bottom surface of the interactive device 14, on opposing side surfaces of the interactive device 14, and the like). For example, the antennas 50 may be spaced such that a pitch or of the antennas and/or a spacing between the antennas are different (e.g., irregular). In such embodiments, the memory 34 of the interactive device 14 may store pitch information for each antenna 50 that indicates a pitch corresponding to each antenna (e.g., a first pitch corresponding to a first antenna, a second pitch corresponding to a second antenna, and so on). In some embodiments, the memory 34 may store position information associated with each antenna 50, such as a distance between one or more of the antennas 50 and/or a position of each antenna 50 on the interactive device. In operation, the processor 32 may receive the signals 100 from each transceiver 42 and determine the time of flight information (e.g., data indicating a time corresponding to receipt of the signals 100) for each of the antenna 50. It should be noted that although five antenna 50 and five transceivers 42 are shown, the interactive device 14 may include any number of antenna 50 and/or transceivers 42. For example, the interactive device 14 may include 2, 3, 4, 5, 6, 7 or more antennas 50 and 1, 2, 3, 4, 5, 6, or more than 6 transceivers 42. That is, the interactive device 14 may include multiple transceivers 42, but less than the number of antennas 50. As such, more than one antenna, but less than the total number of antennas may be operated at a given time by the transceivers 42. It should be noted that including fewer antennas 50 and/or fewer transceivers 42 may reduce the cost of the interactive device 14, as well as utilize less computational resources by the processor 32. One such example illustrated and described with respect to FIG. 5.

In an embodiment, the interactive device 14 may include one transceiver 42 that controls operation of multiple antenna 50. To illustrate this, FIG. 5 shows a schematic diagram of an interactive device 14 having a transceiver 42 that receives signals 100a, 100b, 100c, 100d, and 100e (e.g., collectively 100) via a respective antenna 50a, 50b, 50c, 50d, and 50e (e.g., collectively 50). In a generally similar manner as discussed above, the signals 100 may include the transmitter ID 60. Further, each antenna 50 may be disposed at a different position of the interactive device 14 (e.g., on top of the interactive device 14, on a bottom of the interactive device 14, on opposing sides of the interactive device 14, and the like). In operation, the processor 32 may activate a particular antenna 50 via the transceiver 42 (e.g., in a predetermined sequence or periodically activate each transceiver 42) and the processor 32 may receive the signals 100 from each transceiver 42 and determine data indicating a time corresponding to receipt of the signals 100 by each of the antenna 50. It should be noted that including ratio of transceiver 42 to antennas 50 that is less than 1, may reduce costs associated with the interactive device 14. However, the interactive device 14 may nonetheless be able to determine position information 88 and/or orientation information 90 that may be utilized by the environment controller 18 as described herein.

In an embodiment where a single transceiver 42 is controlling multiple antennas 50, the transceiver 42 may cycle through the antennas 50, one-by-one, using techniques such as time division multiplexing. For example, the transceiver 42 may couple to a first antenna 50a, receive a first signal 100a via the first antenna 50a, and the processor 32 may determine time of flight information associated with the first antenna 50a. Then, the transceiver 42 may couple to a second antenna 50b, receive a second signal 100b via the second antenna 50b, and the processor 32 may determine time of flight information associated with the second antenna 50b, and so on.

In some embodiments, there may be multiple transceivers 42 and more antennas 50 than transceivers 42. As such, the multiple transceivers 42 may cycle through multiple antennas 50. For example, a first transceiver 42 may couple to the first antenna 50a and a second transceiver 42 may couple to the second antenna 50b. The first transceiver 42 may receive a signal 100 via the first antenna 50a and the second transceiver 42 may receive a signal 100 via the second antenna 50b. Then, the processor 32 may determine a first time of flight information associated with the first antenna 50a and a second time of flight information associated with the second antenna 50b. Then, a first transceiver 42 may couple to the third antenna 50c and a second transceiver 42 may couple to the fourth antenna 50d. The first transceiver 42 may receive a signal 100 via the third antenna 50c and the second transceiver 42 may receive a signal 100 via the fourth antenna 50d. Then, the processor 32 may determine a first time of flight information associated with the first antenna 50a and a second time of flight information associated with the fourth antenna 50d, and so on. In this way, the transceivers 42 may each cycle through the antennas 50.

It should be noted that, although the discussion herein generally describes an embodiment where the interactive device 14 is an interactive tool, such as a blaster or projectile device, in some embodiments the interactive device 14 may be a wearable device 14, such as a helmet, a bracelet, a headband, a head-mounted display, or other types of wearable devices. In an embodiment where the interactive device 14 includes a structure with a curved surface, such as a bracelet or a headband (which may support or be part of the head-mounted display), each antenna 50 may be disposed on different positions along the curved surface of the interactive device 14. Accordingly, the curved surface may aid in or result in varying the time of flight for each antenna 50. It is presently recognized that such an embodiment may facilitate tracking an orientation of the user's head (e.g., whether the user is looking up, down, at a feature 26, or at another user) and/or the position of the user within the interactive environment 10.

Further, although the above discussion herein generally relates to communication via signals, such as UWB signals, it should be noted that the techniques described herein may also utilize data-over-sound (DOS) techniques to determine the position information 88 and/or orientation information 90 corresponding to the interactive device 14. For example, one or more of the antennas 50 may be replaced by microphones. Accordingly, in such an embodiment, a microphone may detect a particular sound that is associated with a particular region of the interactive environment 10 (e.g., emitted by a speaker that is at a fixed or otherwise known position in the interactive environment 10), and the microphone may provide the sound to the processor 32 (or the processor 52) to enable the processor 12 (or the processor 52) to determine the location of the interactive device 14 within the interactive environment 10.

Accordingly, the present disclosure relates to techniques for tracking position information 88 and orientation information 90 corresponding to an interactive device 14. In general, the techniques include an interactive device 14 that includes multiple antennas 50 disposed on different positions of an interactive device 14. For example, the antennas 50 may be arranged in an array on one or more surfaces of the interactive device 14. In some embodiments, the antennas 50 may be spaced such that a pitch or of the antennas and/or a spacing between the antennas are different (e.g., irregular). One or more transceivers 42 may receive signals indicating (e.g., including a transmitter ID 60) via one or more antennas that are transmitted by a transceiver 58 via an antenna 66 of the transceiver 58 that is external to the interactive device 14. A processor 32 of the interactive device 14 may determine a time of flight of the information by each of the antennas 50 of the interactive device 14 based on a first timestamp associated with sending of the signals and a second timestamp associated with receipt of the signals. In turn, the processor 32 may determine position information 88, orientation information 90, or both, corresponding to the interactive device 14, and communicate signals indicating the information (e.g., the position information 88, the orientation information 90, or both) to an environment controller 18 that controls features 26 with an interactive environment 10 where the interactive device 14 is being utilized. In this way, the disclosed interactive device system 12 may improve a user's immersion by creating feedback (e.g., adjustment of features 26, awarding points, causing feedback devices 38 to activate) that correspond to interactions between the user and the interactive environment 10.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An interactive device, comprising:
a plurality of antennas;
one or more transceivers coupled to the plurality of antennas;
one or more feedback devices; and
one or more processors coupled to the one or more transceivers and the one or more feedback devices, the one or more processors configured to:
receive, via the one or more transceivers, the signals from a computing device;
determine a time of flight corresponding to receipt of the signals by the plurality of antennas;
determine position information, orientation information, or both, of the interactive device based on the time of flight;
transmit the position information, the orientation information, or both, to an environment controller via the one or more transceivers; and
activate the one or more feedback devices based on the position information, the orientation information, or both.

2. The interactive device of claim 1, wherein the signals comprise ultra-wideband (UWB) signals.

3. The interactive device of claim 1, wherein the plurality of antennas comprise three or more antennas.

4. The interactive device of claim 1, wherein the one or more processors are configured to transmit data indicative of interactions between the interactive device and an interactive environment to the environment controller via the one or more transceivers.

5. The interactive device of claim 1, wherein the one or more processors are configured to transmit an interactive device identifier to the environment controller via the one or more transceivers subsequent to receiving a user identifier.

6. The interactive device of claim 1, wherein the time of flight includes a timestamp corresponding to transmitting the signals by the computing device.

7. The interactive device of claim 1, wherein the antennas are arranged in an array on a surface of the interactive device.

8. The interactive device of claim 1, wherein the interactive device comprises a plurality of transceivers including the transceiver, and wherein a first transceiver of the plurality of transceivers is configured to receive the signals via a first antenna of the plurality of antennas, and wherein a second transceiver of the plurality of transceivers is configured to receive the information via a second antenna of the plurality of antennas.

9. The interactive device of claim 1, wherein the time period corresponding to receipt of the information comprises a time of flight measurement of the information transmitted by the transceiver distinct from the interactive device.

10. The interactive device of claim 1, wherein the orientation information comprises aim information of the interactive device.

11. The interactive device of claim 1, wherein the orientation information comprises roll information of the interactive device.

12. A method, comprising:
transmitting, using a transmitter, a first ultra-wideband (UWB) signal to be received by a plurality of antennas of an interactive device being utilized within an interactive environment;
receiving, using a receiver, a second UWB signal indicating position information, orientation information, and an interactive device identifier associated with the interactive device being utilized within the interactive environment; and
updating, using the one or more processors, one or more features within the interactive environment based on the position information, the orientation information, and the interactive device identifier.

13. The method of claim 12, wherein updating, using the one or more processors, the one or more features within the interactive environment comprises:
retrieving a user profile based on the interactive device identifier; and
updating the user profile based on the position information and the orientation information.

14. The method of claim 12, wherein updating, using the one or more processors, the one or more features within the interactive environment comprises:
determining that the interactive device is aiming at a feature depicted on a display of the interactive environment based on the position information and the orientation information; and
updating the display in response to determining that the interactive device is aiming at the feature depicted on the display screen.

15. The method of claim 12, wherein the orientation information indicates a direction the interactive device is facing, a degree of roll, pitch, a yaw, or any combination thereof.

16. An interactive system, comprising:
an environment controller comprising a transceiver configured to transmit a signal; and
a plurality of interactive devices, wherein each interactive device of the plurality of interactive devices comprises a plurality of antennas, one or more transceivers, and one or more processors, wherein the one or more processors of each interactive device is configured to:
receive a signal from the one or more transceivers via the plurality of antennas of a respective interactive device;
determine a time of flight of the signal based on receipt of the signal via the plurality of antennas;
determine position information and orientation information based on the time of flight of the signal; and
transmit the position information and the orientation information to the environment controller via the plurality of antennas, wherein the environment controller, upon receipt of the position information and the orientation information, is configured to adjust one or more features of an amusement park.

17. The interactive system of claim 16, wherein the environment controller is configured to adjust the one or more features of the amusement park by adjusting one or more images displayed on a display of the amusement park.

18. The interactive system of claim 16, wherein the one or more features comprise one or more feedback devices disposed on the plurality of interactive devices.

19. The interactive system of claim 16, wherein each interactive device of the plurality of interactive devices stores a respective interactive device identifier, and wherein the one or more processors are configured to transmit the interactive device identifier subsequent to receiving the signal.

20. The interactive system of claim 16, wherein the environment controller is configured to adjust the one or more features of the amusement park by actuating one or more physical features of the amusement park.
